(19) United States
(12) Patent Application Publication
(10) Pub. No.: US 2005/0168128 A1
(43) Pub. Date: Aug. 4, 2005

(54) Electron emission device and method of manufacturing the same

(76) Inventor: Jung-Ho Kang, Suwon-si (KR)

Correspondence Address: CHRISTIE, PARKER & HALE, LLP, PO BOX 7068, PASADENA, CA, 91109-7068, US

(21) Appl. No.: 11/046,285

(22) Filed: Jan. 27, 2005

(30) Foreign Application Priority Data
Jan. 29, 2004 (KR) 10-2004-0005726

(51) Int. Cl. H01J 1/62; H01J 63/04

(52) U.S. Cl. 313/495; 313/496

(57) ABSTRACT

An electron emission device includes first and second substrates facing each other, first electrodes formed on the first substrate, and second electrodes separated from the first electrodes by interposing an insulating layer. The first electrodes have first sub electrodes which with a partially removed portions, and second sub electrodes formed on at least one surface of the first sub electrodes with a transparent conductive material. Electron emission regions are formed on the second sub electrodes within the partially removed portions of the first sub electrodes. The electron emission regions are in surface contact with the second sub electrodes.

### CROSS REFERENCE TO RELATED APPLICATION

This application claims priority to and the benefit of Korean Patent Application No. 10-2004-0005726 filed on Jan. 29, 2004 in the Korean Intellectual Property Office, the entire content of which is incorporated herein by reference.

### BACKGROUND OF THE INVENTION

1. Field of the Invention

The present invention relates to an electron emission device, and in particular, to an electron emission device which has an electron emission unit for emitting electrons, and a light emission unit for emitting visible rays due to the electrons to make the displaying.

2. Description of Related Art

Generally, electron emission devices are classified into a first type where a hot cathode is used as an electron emission source, and a second type where a cold cathode is used as the electron emission source.

Among the second type electron emission devices there are known a field emitter array (FEA) type, a metal-insulator-metal (MIM) type, a metal-insulator-semiconductor (MIS) type, a surface conduction emitter (SCE) type, and a ballistic electron surface emitter (BSE) type.

The electron emission devices are differentiated in their specific structure depending upon the types thereof, but basically have first and second substrates forming a vacuum vessel, an electron emission unit formed at the first substrate to emit electrons, and phosphor layers formed at the second substrate to emit light or make the displaying.

With the FEA type electron emission device, electron emission regions are formed with a material capable of emitting electrons under the application of an electric field, and driving electrodes, such as cathode and gate electrodes, are placed around the electron emission regions. When an electric field is formed around the electron emission regions due to the voltage difference between the cathode and the gate electrodes, electrons are emitted from the electron emission regions.

With a typical structure of the FEA type electron emission device, cathode electrodes, an insulating layer and gate electrodes are sequentially formed on the first substrate, and openings are formed at the insulating layer and the gate electrodes while partially exposing the cathode electrodes. Electron emission regions are formed on the cathode electrodes within the openings. With another typical structure of the FEA type electron emission device, gate electrodes, an insulating layer and cathode electrodes are sequentially formed on the first substrate, and electron emission regions are formed at the lateral sides of the cathode electrodes.

In the above-structured electron emission device, electron emission regions are patterned through coating a photosensitive electron emitting material onto the entire surface of the first substrate, selectively exposing it to light, and developing it. During the light exposing process, when ultraviolet rays are illuminated over the electron emitting material, the electron emission region pattern becomes non-uniform, and the adhesive force of the electron emission regions becomes deteriorated.

Accordingly, a backside-exposure technique has been recently developed to illuminate the ultraviolet rays through the rear surface of the first substrate. The electron emission device taking the backside-exposure technique uses a sacrificial layer for patterning the electron emission regions, and hence, does not require a separate light exposing mask. As the cross-linking of the photosensitizer is made from the bottom of the electron emission regions, the risk of detachment of the electron emitting material during the developing process is reduced.

In order to apply the backside-exposure technique to the above-described first typical structure of the FEA type electron emission device, holes are formed at the cathode electrodes (usually based on metal) while opening the locations to be formed with electron emission regions, and ultraviolet rays are illuminated through those holes. Consequently, electron emission regions are formed within the holes of the cathode electrodes while filling those holes. The electron emission regions only contact the lateral sides of the cathode electrodes.

In order to apply the backside-exposure technique to the above-described second typical structure of the FEA type electron emission device, the gate electrodes and the insulating layer are formed with a transparent material. A sacrificial layer is formed on the entire surface of the first substrate with the gate electrodes, the insulating layer and the cathode electrodes, and patterned such that holes are formed thereon at the lateral sides of the cathode electrodes to open the locations for the electron emission regions. A photosensitive electron emitting material is coated onto the entire surface of the first substrate, exposed to light using the backside-exposure technique, and developed to thereby form electron emission regions. The resulting electron emission regions contact the cathode electrodes only at the lateral sides thereof.

With the structure where the electron emission regions contact the lateral sides of the cathode electrodes, after the electron emission regions are surface-treated to enhance the electron emission efficiency, the contact area between the electron emission regions and the cathode electrodes becomes reduced. Consequently, with the conventional electron emission device, the reduction in the contact area between the electron emission regions and the cathode electrodes causes an increase in the contact resistance between them, non-uniformity in the electron emission, and increase in the driving voltage.

### SUMMARY OF THE INVENTION

In one exemplary embodiment of the present invention, there is provided an electron emission device, and a method of manufacturing the same which forms electron emission regions using a backside-exposure technique while enhancing the device characteristics.

In an exemplary embodiment of the present invention, the electron emission device includes first and second substrates facing each other at a predetermined distance, first electrodes formed on the first substrate, and second electrodes separated from the first electrodes by interposing an insulating layer. The first electrodes have first sub electrodes with a partially removed poartions, and second sub electrodes formed with a transparent conductive material on at least one surface of the first sub electrodes. Electron emission regions are formed on the second sub electrodes within the partially removed poartions while filling the portions. The electron emission regions are in surface contact with the second sub electrodes.

The electron emission regions may be formed within the first sub electrodes, and the second sub electrodes are placed on the bottom surface of the first sub electrodes with the partially removed portions. Alternatively, the partially removed portions may be formed at the one-sided peripheries of the first sub electrodes with a concave shape, and the second sub electrodes are placed under the one-sided peripheries of the first sub electrodes with the partially removed portions.

The first sub electrodes may be formed with a metallic conductive material, and the second sub electrodes with indium tin oxide (ITO).

The electron emission device further includes at least one anode electrode formed on the second substrate, and phosphor layers formed on any one surface of the anode electrode.

In a method of manufacturing the electron emission device, second sub electrodes are first formed on a first substrate with a transparent conductive material, and first sub electrodes are then formed with a non-transparent conductive material such that the first sub electrodes have a partially removed portions, and cover the second sub electrodes, thereby forming first electrodes with the first and the second sub electrodes. An insulating layer is formed on the entire surface of the first substrate such that the insulating layer covers the first electrodes. Second electrodes are formed on the insulating layer. At least one opening portion is formed at the second electrode and the insulating layer per the respective crossed regions of the first and the second electrodes while exposing the partially removed portion. A photosensitive electron emitting material is coated on the partially removed portions, and exposed to light through the rear surface of the first substrate to thereby form electron emission regions.

According to another aspect of the present invention, in a method of manufacturing the electron emission device, second electrodes are formed on a first substrate with a transparent conductive material. An insulating layer is formed on the entire surface of the first substrate with a transparent dielectric material such that the insulating layer covers the second electrodes. Thereafter, second sub electrodes are first formed on the insulating layer with a transparent conductive material, and first sub electrodes are then formed with a non-transparent conductive material such that the first sub electrodes have partially removed portions, and cover the second sub electrodes, thereby forming first electrodes with the first and the second sub electrodes. A photosensitive electron emitting material is coated on the partially removed portions, and exposed to light through the rear surface of the first substrate to thereby form electron emission regions.

### BRIEF DESCRIPTION OF THE DRAWINGS

FIG. 1 is a partial exploded perspective view of an electron emission device according to a first embodiment of the present invention.

FIG. 2 is a partial sectional view of the electron emission device shown in FIG. 1, illustrating the combinatorial state thereof.

FIGS. 3A to 3D schematically illustrate the steps of manufacturing the electron emission device according to the first embodiment of the present invention.

FIG. 4 is a partial exploded perspective view of an electron emission device according to a second embodiment of the present invention.

FIG. 5 is a partial sectional view of the electron emission device shown in FIG. 4.

FIGS. 6A to 6D schematically illustrate the steps of manufacturing the electron emission device according to the second embodiment of the present invention.

### DETAILED DESCRIPTION

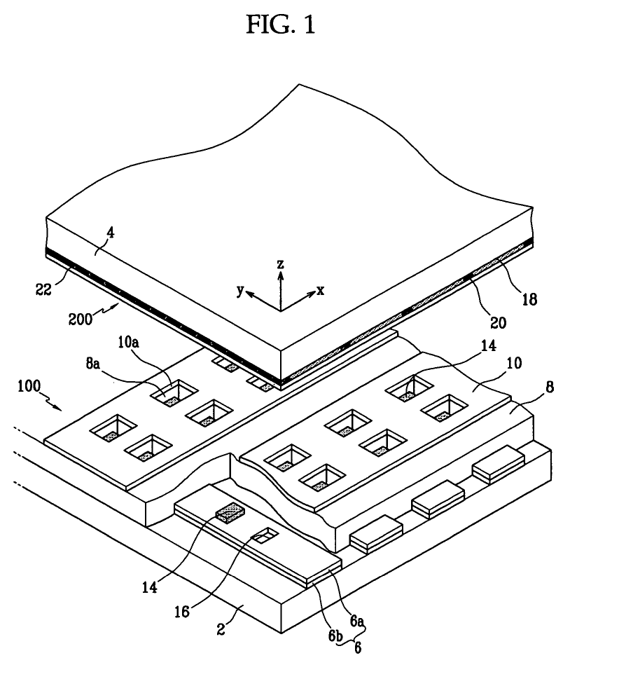

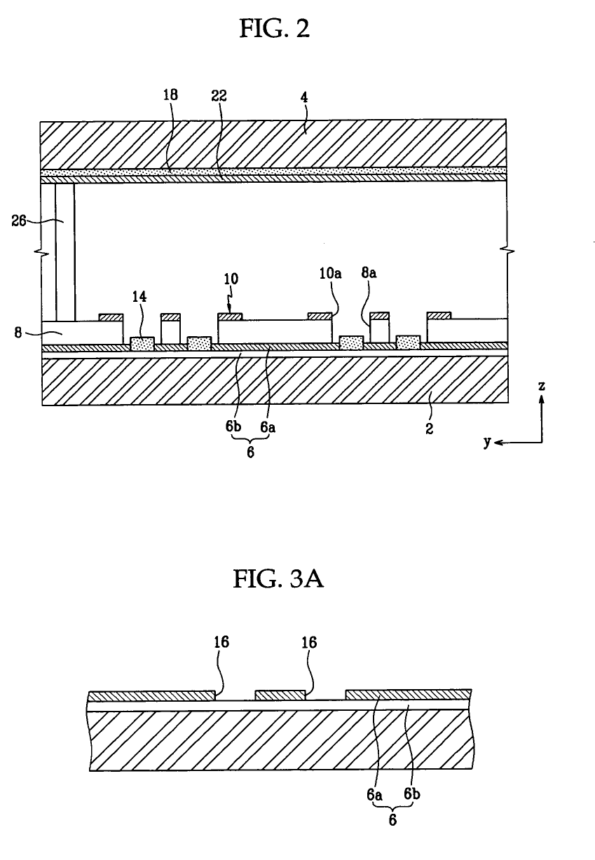

Referring to FIGS. 1 and 2, the electron emission display device has first and second substrates 2, 4 spaced apart from each other at a predetermined distance while forming an internal space. The first and the second substrates 2, 4 are parallel to each other, and are combined to form a vacuum vessel outlining the electron emission device. An electron emission unit 100 is provided at the first substrate 2 to emit electrons, and a light emission unit 200 is provided at the second substrate 4 to emit visible rays due to the emitted electrons.

Specifically, a plurality of first electrodes 6 (referred to hereinafter as “cathode electrodes”) with a predetermined pattern (for instance, a striped shape) are formed on the first substrate 2 such that they are spaced apart from each other at a predetermined distance while proceeding in a Y axis direction. An insulating layer 8 is formed on the entire surface of the first substrate 2 such that it covers the cathode electrodes 6. Second electrodes 10 (referred to hereinafter as “gate electrodes”) are formed on the insulating layer 18 while being spaced apart from each other at a predetermined distance, and proceed in a direction crossing the cathode electrodes 6 in an X axis direction.

In this embodiment, when the crossed regions of the cathode electrodes 6 and the gate electrodes 10 are defined as pixel regions, the pixel regions are arranged in matrix pattern for driving the electron emission device. At least one hole 10a, 8a is formed at the gate electrode 10 and at the insulating layer 8 per the respective pixel regions while partially exposing the cathode electrode 6. Electron emission regions 14 are formed on the exposed portions of the cathode electrode 6.

The cathode electrode 6 has a nontransparent first sub electrode 6a mounting a partially removed portion 16 therein, and a transparent second sub electrode 6b formed under the removed portion 16 and the first sub electrode 6a. The first sub electrode 6a is formed with a metallic material capable of being patterned at high definition with a low resistance, such as chrome (Cr), aluminum (Al), and molybdenum (Mo). The second sub electrode 6b is preferably formed with ITO such that the electron emission regions can be formed using a backside-exposure technique.

Electron emission regions 14 are formed within the removed portions 16 while filling them. The electron emission regions 14 are formed on the second sub electrodes 6b while being in surface contact therewith, and contact the lateral sides of the first sub electrodes 6a. Although it is illustrated in the drawings that two removed portions 16 are formed at the respective pixel regions in the shape of a rectangle, the number and the shape of the removed portions 16 are not limited thereto, but may be altered in various manners.

In this embodiment, the electron emission regions 14 are formed with a material capable of emitting electrons under the application of an electric field, such as a carbonaceous material and a nanometer-sized material. In exemplary embodiments electron emission regions 14 are formed with carbon nano-tube, graphite, diamond-like carbon, C₆₀, or a combination thereof. The nanometer-sized material may include nano-tube, nano-wire, nano-fiber, and a combination thereof.

Phosphor layers 18, for example red, green and blue phosphor layers are arranged on the surface of the second substrate 4 facing the first substrate 2 at a predetermined distance, and black layers 18 are disposed between the phosphor layers 18 to enhance the screen contrast. An anode electrode 22 is formed on the phosphor layers 18 and the black layers 20 through depositing a metallic layer (for instance, an aluminum layer) thereon. The anode electrode 22 receives the voltage required for accelerating the electron beams from the outside, and enhances the screen brightness due to the metal back effect.

The anode electrode may be formed with a transparent conductive material, such as ITO. In this case, an anode electrode (not shown) based on a transparent conductive material is first formed on the second substrate 4, and the phosphor layers 18 and the black layers 20 are formed on the anode electrode. When required, a metallic layer may be formed on the phosphor layers 18 and the black layers 20 to enhance the screen brightness. The anode electrode may be formed on the entire surface of the second substrate 4, or patterned with separate portions.

With the above-structured electron emission device, when a predetermined driving voltage is applied to the cathode electrode 6 and the gate electrode 10, an electric field is formed around the electron emission region 14 due to the voltage difference between the two electrodes, and electrons are emitted from the electron emission region 14. The emitted electrons are attracted by the high voltage applied to the anode electrode 22, and directed toward the second substrate 4. The electrons collide against the phosphor layer 18 at the relevant pixel, and emit light to thereby display a desired image.

With the electron emission device according to the embodiment of the present invention, as the second sub electrode 6b is placed under the electron emission region 14 while communicating with the first sub electrode 6a, the electron emission region 14 is in surface contact with the second sub electrode 6b so that the possible problems due to the small contact area between the first electrode 6a and the electron emission region 14 can be effectively prevented.

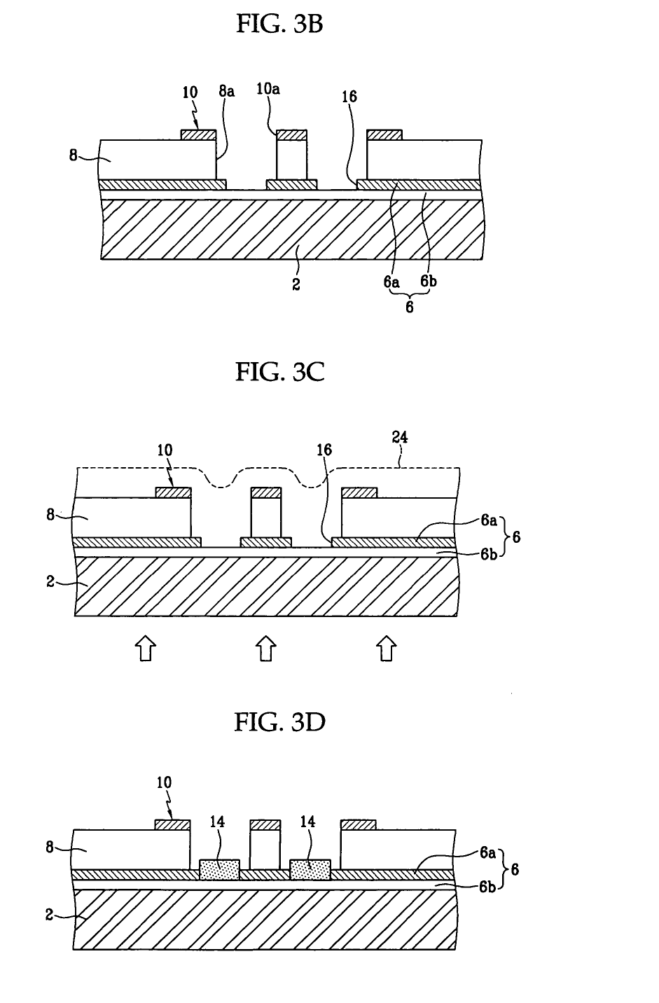

A method of manufacturing an electron emission device will be now explained. FIGS. 3A to 3D schematically illustrate the steps of manufacturing the electron emission device according to the embodiment of the present invention.

As shown in FIG. 3A, second sub electrodes 6b are formed on a transparent first substrate 2 with a transparent conductive material, such as ITO. The second sub electrodes 6b may be formed through depositing a layer by sputtering or dipping, and patterning the layer by photolithography or etching, or using a lift off technique where a photoresist pattern is first formed, and after the second sub electrodes 6b are formed, the photoresist pattern is removed.

Thereafter, first sub electrodes 6a are formed on the second sub electrodes 6b with a metallic material, such as Cr, Al and Mo. The first sub electrodes 6a are patterned to thereby form partially removed portions 16 within the first sub electrodes 6a. Consequently, cathode electrodes 6 with the first and the second sub electrodes 6a and 6b are formed.

As shown in FIG. 3B, an insulating layer 8 is formed on the entire surface of the first substrate 2 while covering the cathode electrodes 6 through printing, drying and firing a dielectric material. When the printing, drying and firing processes are repeated twice, an insulating layer 8 with a thickness of about 10-30 μm can be obtained. Subsequently, a conductive layer is deposited on the insulating layer 8, and patterned to thereby form gate electrodes 10 crossing the cathode electrodes 6.

At least one opening portion 10a, 8a (two opening portions are exemplified in the drawings) are formed at the gate electrodes 10 and the insulating layer 8 per the respective pixel regions where the cathode and the gate electrodes 6 and 10 cross each other while partially exposing the cathode electrode 6 with the removed portion 16. The opening portion 10a and 8a may be formed using photolithography and etching.

As shown in FIG. 3C, a photosensitive electron emitting material 24 is coated on the entire surface of the first substrate 2, and ultraviolet rays (indicated by arrows) are illuminated thereon through the rear surface of the first substrate 2, thereby hardening the electron emitting material 24 filled within the removed portions 16 in a selective manner, and removing the non-hardened electron emitting material through developing. Consequently, as shown in FIG. 3D, electron emission regions 14 with a thickness of several micrometers are formed.

Finally, as shown in FIG. 2, spacers 26 are formed on the first substrate, and phosphor layers 18 and an anode electrode 22 are formed on the second substrate 4. The first and the second substrates 2, 4 are sealed to each other at their peripheries using a sealant (not shown), and the inside of the first and the second substrates 2, 4 is exhausted, thereby completing the electron emission device.

It is exemplarily illustrated that the second sub electrodes 6b of the cathode electrodes 6 are formed with a stripe pattern. The second sub electrodes 6b may be also formed with a non-continuous stripe pattern, or the same pattern as the first sub electrodes 6a.

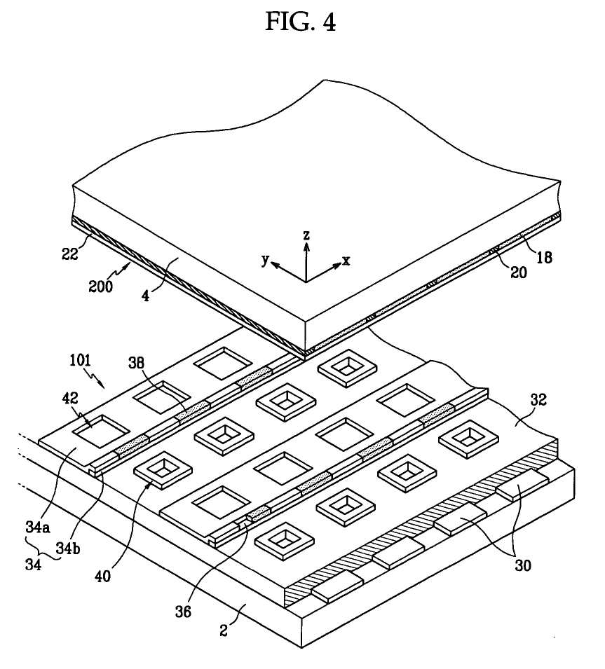

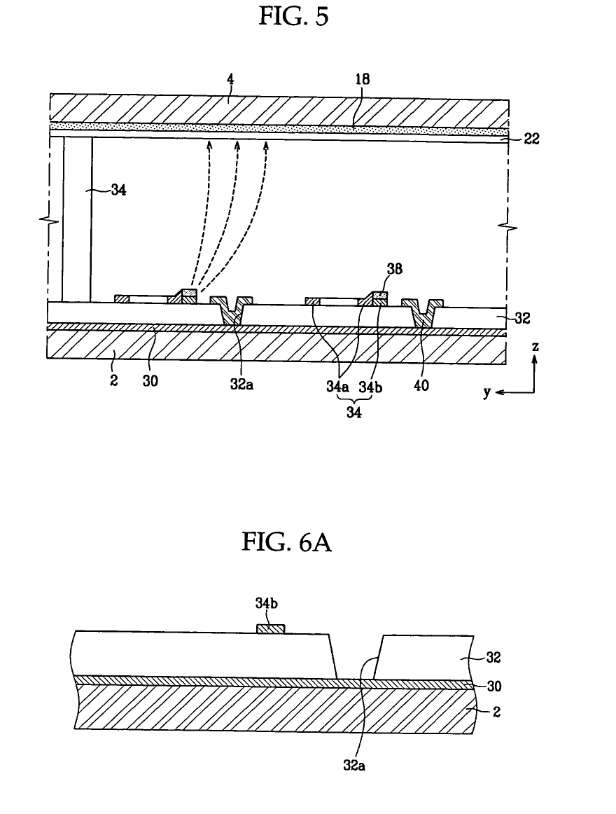

FIG. 4 is a partially exploded perspective view of an electron emission device according a second embodiment of the present invention, and FIG. 5 is a partial sectional view of the electron emission device. The structure of the light emission unit 200 provided at the second substrate 2 is the same as that of the first embodiment, and hence, only the structure of the electron emission unit 101 will be now explained.

As shown in FIG. 4, a plurality of transparent gate electrodes 30 with a predetermined pattern (for instance, a stripe shape) are formed on the first substrate 2 such that they are spaced apart from each other at a predetermined distance while proceeding in the Y axis direction. A transparent insulating layer 32 is formed on the entire surface of the first substrate 2 such that it covers the gate electrodes 30. A plurality of first sub electrodes 34a are formed on the insulating layer 32 while being spaced apart from each other at a predetermined distance, and proceed in a direction crossing the gate electrodes 30 in the X axis direction. A portions 36 which that the first sub electrode 34a are partially removed, are formed at the one-sided peripheries of the first sub electrodes 34a each per the respective crossed regions of the gate electrodes 30 and the first sub electrodes 34a. Electron emission regions 38 are placed at the removed portions 36.

Transparent second sub electrodes 34b are placed under the electron emission regions 38 and are electrically connected to the first sub electrodes 34a. The second sub electrodes 34b contact the bottom surfaces of the electron emission regions 38 to remove the possible problems conventionally induced by the linear contacting between the electron emission regions 38 and the first sub electrodes 34a. The first sub electrodes 34a are formed with a metallic material capable of being patterned at high definition with a low resistance, such as Cr, Al and Mo. The second sub electrodes 34b may be formed with ITO such that the electron emission regions 38 can be formed using a backside-exposure technique. The second sub electrodes 34b are placed under the one-sided peripheries of the first sub electrodes 34a with the electron emission regions 38.

Counter electrodes 40 may be formed on the first substrate 2 to pull up the electric fields of the gate electrodes 30 over the insulating layer 32. The counter electrodes 40 contact the gate electrodes 30 through via holes 32a formed at the insulating layer 32 while being electrically connected thereto, and are spaced apart from the electron emission regions 38 between the cathode electrodes 34 at a predetermined distance. The counter electrodes 40 provide for a stronger electric field to be applied to the electron emission regions 38 such that electrons are well emitted from the electron emission regions 38.

Furthermore, electric field reinforcing holes 42 are formed opposite to the counter electrodes 40 around the electron emission regions 38 by partially removing the first sub electrodes 34a of the cathode electrodes 34. The holes 42 play a role similar to that of the counter electrodes 40.

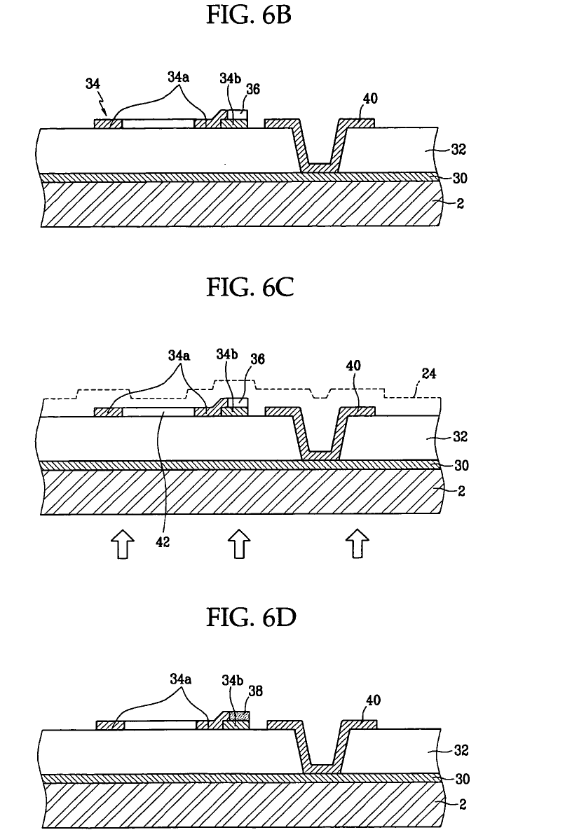

A method of manufacturing an electron emission device will be now explained, referring to FIGS. 6A to 6D which illustrate the steps of manufacturing an electron emission device according to the second embodiment of the present invention.

As shown in FIG. 6A, a transparent conductive material, such as ITO, is sputtered or coated onto a transparent first substrate 2, and patterned through photolithography to thereby form gate electrodes 30.

A transparent dielectric material is printed onto the entire surface of the first substrate 2, dried and baked to thereby form an insulating layer 32. Thereafter, via holes 32a are formed at the insulating layer 32 through photolithography or wet etching while partially exposing the gate electrodes 30. Counter electrodes will be formed at the via holes 32a to be electrically connected to the gate electrodes 30.

Thereafter, second sub electrodes 34b are formed on the insulating layer 32 with a transparent conductive material, such as ITO. The second sub electrodes 34b will form cathode electrodes together with first sub electrodes to be subsequently formed. In one embodiment, the thickness of the second sub electrodes 34b is minimized to be 0.05-5 μm such that the first sub electrodes completely cover the second sub electrodes.

As shown in FIG. 6B, first sub electrodes 34a are formed on the specific region of the first substrate 2 with a metallic material, such as Cr, Al and Mo. In this way, cathode electrodes 34 with the first and the second sub electrodes 34a and 34b are completed.

In an exemplary embodiment the first sub electrodes 34a are formed with a width larger than that of the second sub electrodes 34b. When the first sub electrodes 34a are formed, removed portions 36 are formed along the one-sided peripheries of the first sub electrodes 34a facing the counter electrodes 40 to provide the space for the electron emission regions. The portions of the first sub electrodes 34a placed opposite to the counter electrodes 40 are removed to thereby form electric field reinforcing holes 42.

As shown in FIG. 6C, a photosensitive electron emitting material 24 is screen-printed onto the entire surface of the first substrate 2. Ultraviolet rays (indicated by arrows) are illuminated thereon through the rear surface of the first substrate 2, thereby hardening the electron emitting material 24 filled within the removed portions 36 in a selective manner, and removing the non-hardened electron emitting material through developing. Consequently, as shown in FIG. 6D, electron emission regions 38 are formed.

Although it is exemplified above that the second sub electrodes 34b of the cathode electrodes 34 are formed in a stripe pattern, the second sub electrodes 34b may be formed with a non-continuous stripe pattern, the same pattern as the first sub electrodes 34a, or other various patterns.

As described above, the inventive structure concerns the FEA type electron emission device. However, the structure is not limited to the FEA type electron emission device, but may be also applied to other electron emission devices.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

1. An electron emission device comprising:
a first substrate and a second substrate adapted to face each other at a predetermined distance;
first electrodes formed on the first substrate, the first electrodes having first sub electrodes which has a partially removed portions, and second sub electrodes formed with transparent conductive material on at least one surface of the first sub electrodes;
second electrodes separated from the first electrodes by interposing an insulating layer; and
electron emission regions formed on the second sub electrodes within the partially removed portions and filling the portions, the electron emission regions being in surface contact with the second sub electrodes.

2. The electron emission device of claim 1 where the first sub electrodes cover the second sub electrodes.

3. The electron emission device of claim 2 wherein the partially removed portions are formed within the first sub electrodes, and the second sub electrodes are placed on the bottom surface of the first sub electrodes with the partially removed portions.

4. The electron emission device of claim 3 wherein the first electrodes, the insulating layer and the second electrodes are sequentially formed on the first substrate, the first and the second electrodes crossing each other, at least one opening portion being formed at the second electrode and the insulating layer at the respective crossed regions of the first and the second electrodes, and the partially removed portion and the electron emission region are placed within the opening portion.

5. The electron emission device of claim 2 wherein the partially removed portions are formed at the one-sided peripheries of the first sub electrodes with a concave shape, and the second sub electrodes are placed under the one-sided peripheries of the first sub electrodes with the partially removed portions.

6. The electron emission device of claim 5 wherein the second electrodes, the insulating layer and the first electrodes are sequentially formed on the first substrate, and the second and the first electrodes cross each other.

7. The electron emission device of claim 6 further comprising counter electrodes formed on the insulating layer between the first electrodes while being electrically connected to the second electrodes, and spaced apart from the electron emission regions at a predetermined distance.

8. The electron emission device of claim 1 wherein the first sub electrodes are formed with a metallic conductive layer, and the second sub electrodes are formed with indium tin oxide.

9. An electron emission device comprising:
a first substrate and a second substrate adapted to face each other at a predetermined distance;
first electrodes formed on the first substrate, the first electrode having first sub electrodes which has a partially removed portions, and second sub electrodes formed with a transparent conductive material on at least one surface of the first sub electrodes;
second electrodes separated from the first electrodes by interposing an insulating layer;
electron emission regions placed within the partially removed portions while filling the portions, and formed on the second sub electrodes while being in surface contact with the second sub electrodes;
at least one anode electrode formed on the second substrate; and
phosphor layers formed on any one surface of the anode electrode.

10. A method of manufacturing an electron emission device, the method comprising the steps of:
forming second sub electrodes on a first substrate with a transparent conductive material;
forming first sub electrodes with a non-transparent conductive material such that the first sub electrodes have a partially removed portions, and cover the second sub electrodes, thereby forming first electrodes combining the first sub electrodes and the second sub electrodes;
forming an insulating layer on the entire surface of the first substrate such that the insulating layer covers the first electrodes;
forming second electrodes on the insulating layer;
forming at least one opening portion at the second electrode and the insulating layer for respective crossed regions of the first and the second electrodes while exposing the partially removed portion; and
coating a photosensitive electron emitting material on the partially removed portions and exposing the coated to light through the rear surface of the first substrate to thereby form electron emission regions.

11. A method of manufacturing an electron emission device, the method comprising the steps of:
forming second electrodes on a first substrate with a transparent conductive material;
forming an insulating layer on the entire surface of the first substrate with a transparent dielectric material such that the insulating layer covers the second electrodes;
forming second sub electrodes on the insulating layer with a transparent conductive material, and forming first sub electrodes with a non-transparent conductive material such that the first sub electrodes have a partially removed portions, and cover the second sub electrodes, thereby forming first electrodes combining the first sub electrodes and the second sub electrodes; and
coating a photosensitive electron emitting material on the partially removed portions, and exposing the photosensitive electron emitting material to light through the rear surface of the first substrate to thereby form electron emission regions.

12. The method of claim 11 wherein when the insulating layer is formed, via holes are formed at the insulating layer, and when the first electrodes are formed, an electrode material fills the via holes to thereby form counter electrodes.
